(19) United States
(12) Patent Application Publication
(10) Pub. No.: US 2025/0032228 A1
(43) Pub. Date: Jan. 30, 2025

(54) DEVICE FOR THE RESIN PRESSING AND FINALIZATION OF FULLY OR PARTIALLY REMOVABLE DENTAL PROSTHESES, AND METHOD FOR PROVIDING IT

(71) Applicant: Dental Manufacturing S.p.A., Badia Polesine (IT)

(72) Inventor: Fabrizio MOLINELLI, Ispra (IT)

(21) Appl. No.: 18/704,706

(22) PCT Filed: Aug. 23, 2022
(86) PCT No.: PCT/EP2022/073388

§ 371 Date: Apr. 25, 2024

(30) Foreign Application Priority Data
Oct. 26, 2021 (IT) 102021000027419

(51) Int. Cl. A61C 13/00

(52) U.S. Cl. CPC A61C 13/0028; A61C 13/0019

(57) ABSTRACT

A device is provided for resin pressing and finalization of removable dental prostheses. The device has a single body which is substantially shaped like a tray and reproduces an entire impression of a prosthesis. The device includes a plurality of artificial teeth embedded in a prosthetic body.

The present invention relates to a device for the resin pressing and finalization of fully or partially removable dental prostheses.

The invention also relates to a method for providing such device.

Nowadays in order to provide fully or partially removable dental prostheses, to be applied to patients suffering from total or partial edentulism, two methods of providing are mainly used:
an analog type, more widespread and conventional,
a digital type, more innovative, but not yet well codified, or widely used.

The analog method comprises many kinds of machining of a typically artisan nature and which depend predominantly on the experience and skill of the technician making the prosthesis.

Such analog method exhibits the drawback of not being standardized and codified.

Furthermore, in the analog method, the transmission of data from the dental surgery to the prosthodontic laboratory, where the prosthesis is made, occurs via the odontologist taking physical impressions of the edentulous arches, directly in the oral cavity of the patient.

This method entails the drawback of having to physically dispatch those impressions to the prosthodontic laboratory for the various steps of machining, and this requires many dispatches back and forth between the surgery and the laboratory, for each phase of machining work.

In particular, the analog method requires at least five appointments for the patient at the dental surgery and consequent collections and deliveries by the prosthodontic laboratory.

The expenditure of time and resources used results in considerable costs for the prosthesis and in slowness of the production process.

The digital method, introduced in recent years, requires a considerable knowledge and specific skill that requires, differently from the analog method, the use of standardized and codified operating protocols.

In the digital method, currently, the transmission of data from the dental surgery to the prosthodontic laboratory still occurs, partially, by dispatching physical impressions.

This is because the sector is not yet completely digitized in recording impressions on the patient.

In the majority of cases, the preliminary data of the patient is sent to the laboratory in a conventional manner, and only subsequently it is sent digitally.

For fully-removable prostheses, the digital method is still sparsely used in that it is not considered operationally and economically comparable to the analog method.

Nowadays, the products currently offered by the market for manufacturing fully-removable prostheses using the digital method represent production processes that involve the use of software and hardware apparatuses which are considerably expensive and complex to use for people who do not have the specific expertise.

Such conventional techniques, furthermore, also have other drawbacks.

The use of these two production methods does not make it possible to provide a prostheses that is completely adaptable to the specific shape of the mouth and of the face of the individual patient, with consequent aesthetic and functional dissatisfaction on the part of the patient.

Furthermore, although starting from impressions of the arches of the patient, in order to provide the prosthesis by adapting the artificial teeth as much as possible to the shape of the mouth and of the face of the patient, the technician needs to physically insert the individual teeth into the support, by trial and error, taking a considerable period of time which also results in considerable production costs and the risk of incorrectly positioning the back teeth.

Finally, before completing the prosthesis and applying it to the patient, it is not possible to view the aesthetic result.

This determines the need to execute several aesthetic and functional tests deriving from the arbitrary execution of a mounting of the artificial teeth based on indications given by inconsistent bite wax arches or based on oral or written clinical indications which are not always exhaustive.

In order to overcome all these drawbacks, a guide apparatus is known for mounting artificial teeth in a dental prostheses, and a method for providing it, by this same applicant and disclosed in Italian patent no. 102019000003367.

This apparatus comprises:
an anatomical base, which reproduces an edentulous surface of a patient,
a guiding device for mounting artificial teeth, reproducing the impression of the morphology of one or more of such artificial teeth, which define at least partially at least one dental arch of the patient.

The apparatus is provided using a method which consists of the following steps:
taking photographs of the face and mouth of the patient,
transferring the photographs using software to form a digital model of the face of the patient and of the edentulous surfaces,
photographically analyzing the physiognomic characteristics of the face of the patient,
using a photographic database containing a library of artificial teeth, selecting, positioning and viewing, in 2D (two-dimensional) format, the dental shapes that are most suited to this type of face,
importing in 3D (three-dimensional) digital format, from a predefined database, the dental shapes selected and viewed previously in 2D format, arranging them on the digital model of these edentulous surfaces obtained from the photographs, thus obtaining a dental composition that is anatomically and functionally correct for the specific patient, in so doing producing a digital prototype,
generating, from such digital prototype, two digital files in STL (Standard Triangulation Language) format, which reproduce the anatomical base and the guiding device, which reproduces the impression of the morphology of such teeth defined by the previously-selected dental shapes,
exporting the STL files to a CAD/CAM (Computer-Aided Design/Computer-Aided Manufacturing) environment for production by 3D printing and/or milling of a solid.

Such apparatus and manufacturing method have met with enormous success from the commercial point of view, but naturally with the passage of time improvements will be sought.

These improvements are aimed at improving aspects of this known art, and of other, similar conventional apparatuses, which display room for improvement.

In particular, one aspect that shows room for improvement is that of the resin pressing and finalization of the dental prostheses.

With conventional apparatuses in fact, the operations of resin pressing and finalization of the prostheses with conventional/special acrylic resins are complex, both for permanent use in the oral cavity and for use with commercial artificial teeth, owing to the shape of the guiding device.

Furthermore, in conventional apparatuses the guiding device only partially reproduces the impression of the morphology of the artificial teeth, which may be defined by the previously-selected dental shapes, but not the impression of the morphology of the prosthetic body, to be provided, which must be modeled anatomically in order to also reproduce the shape of the gingival necks and of the gingival vestibule of the mouth of the patient.

In the present description, the term “prosthetic body” is used to mean the portion of the dental prosthesis in which the artificial teeth are embedded and which comes into contact with the palate of the upper and lower maxillary bone.

The aim of the present invention is to provide a device for the resin pressing and finalization of fully or partially removable dental prostheses, and a method for providing it, that are capable of improving the known art in one or more of the above-mentioned aspects.

Within this aim, an object of the invention is to provide a device for the resin pressing and finalization of fully or partially removable dental prostheses that enables the resin pressing and finalization of prostheses via the injection or casting of resins, such as conventional/special acrylic resins for permanent use in the oral cavity and for use with commercial dedicated artificial teeth.

Another object of the invention is to provide a device for the resin pressing and finalization of fully or partially removable dental prostheses, and a method for providing it, which make it possible to reproduce both the impression of the morphology of the artificial teeth, defined by previously-selected dental shapes, and also the impression of the morphology of the anatomically-modeled prosthetic body in order to reproduce the shape of the gingival necks and the shape of the entire gingival vestibule of the mouth of the patient.

Another object of the invention is to develop a method for providing a device for the resin pressing and finalization of fully or partially removable dental prostheses that is adaptable solely to the patient being fitted, and with which it is possible to obtain a total or partial prostheses while reducing to the minimum the number of clinical sittings at the dental surgery.

A still further object of the present invention is to overcome the drawbacks of the background art in a manner that is alternative to any existing solutions.

Another object of the invention is to provide a device for the resin pressing and finalization of fully or partially removable dental prostheses, and a method for providing such device, that are highly reliable, easy to implement and of low cost.

This aim and these and other objects which will become better apparent hereinafter are achieved by a device for the resin pressing and finalization of removable dental prostheses, characterized in that it has a single body which is substantially shaped like a tray and reproduces the entire impression of a prosthesis, the latter comprising a plurality of artificial teeth embedded in a prosthetic body.

This aim and these and other objects which will become better apparent hereinafter are achieved by a method for providing such a device, which consists in:
taking photographs of the face and mouth of the patient,
transferring these photographs using software to form a digital model of the face of the patient and of the edentulous surfaces,
photographically analyzing the physiognomic characteristics of the face of the patient,
using a photographic database containing a library of artificial teeth, selecting, positioning and viewing, in 2D format, the dental shapes that are most suited to the type of face being considered,
importing in 3D digital format, from a predefined database, the dental shapes selected and viewed previously in 2D format, arranging them on the digital model of the edentulous surfaces obtained from the photographs, thus obtaining a dental composition that is anatomically and functionally correct for the specific patient, in so doing producing a digital prototype,
digitally modeling the prosthetic body of a prosthesis, designing its peripheral limits and the portions for joining to the artificial teeth that were positioned beforehand on the digital prototype, thus obtaining an overall digital model of the prosthesis which is coupled to the edentulous surfaces obtained from STL files of the models or of the arches deriving from scans/photographs,
drawing said device, faithfully tracing the overall digital model obtained in the preceding step,
exporting the STL file of the drawing of the device, obtained in the preceding step, in a CAD/CAM environment for production by 3D printing,
providing said device by 3D printing.

Further characteristics and advantages of the invention will become better apparent from the detailed description that follows of a preferred, but not exclusive, embodiment, of the device for the resin pressing and finalization of fully or partially removable dental prostheses, and of the method for providing it, according to the invention, which are illustrated, by way of non-limiting example, in the accompanying drawings, wherein:

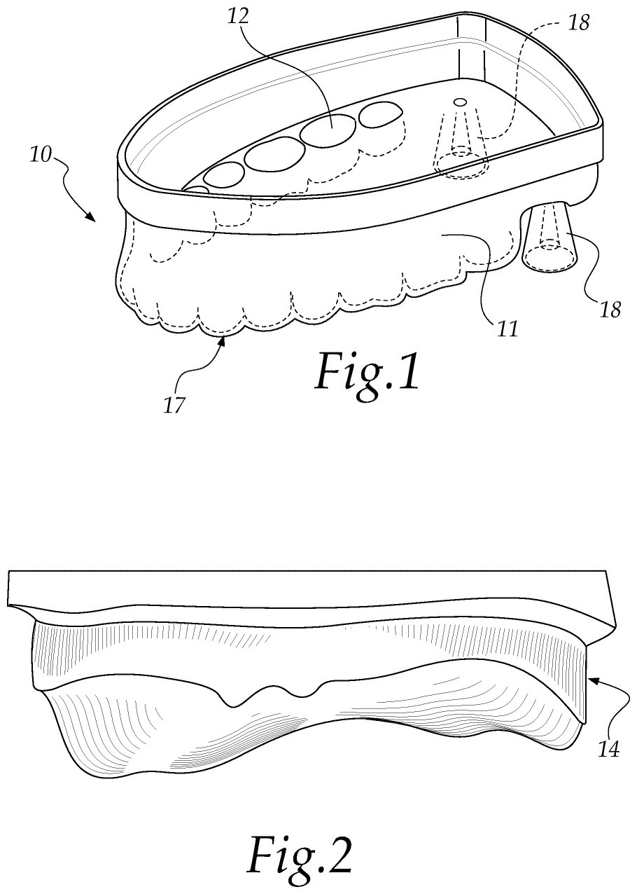

FIG. 1 is an overall perspective view of a device for the resin pressing and finalization of fully or partially removable dental prostheses according to the invention;

FIGS. 2 to 4 are side views, of which FIG. 4 is a partial cross-sectional view, each view showing a step of providing a dental prosthesis, using the device of FIG. 1.

With reference to the figures, a device for the resin pressing and finalization of fully or partially removable dental prostheses, according to the invention, is generally designated by the reference numeral 10.

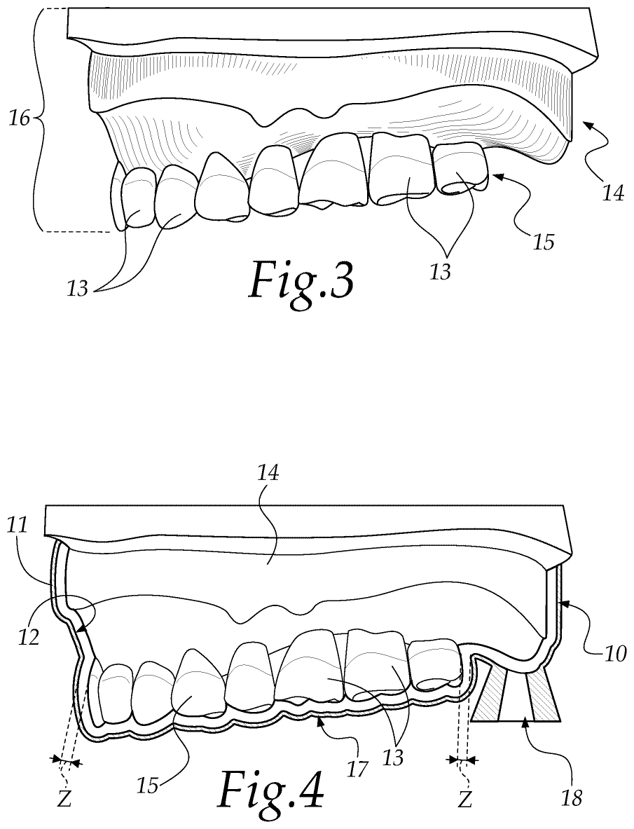

The device 10 has a single body 11 which is substantially shaped like a tray and reproduces the entire impression 12 of the prosthesis 15 (partly shown in FIGS. 3 and 4), the latter comprising a plurality of artificial teeth 13 embedded in a prosthetic body (not shown in the figures).

The term “entire impression of the prosthesis” in the present description is used to mean that the impression is defined:
by the morphology of the artificial teeth 13 of the prosthesis 15, which are already arranged in their final configuration,
by the morphology of the prosthetic body, which is modeled anatomically in order to reproduce the shape of the gingival necks and of the covering of the gingival vestibule of the patient being fitted.

In particular, the body 11 is internally shaped complementarily to an assembly 16 which is constituted by:
an anatomical base 14, shown on its own in FIG. 2, which reproduces an edentulous surface of the patient being fitted,
the plurality of teeth 13 of the prosthesis 15, which are mounted on the base 14,
and has, in the configuration for use, a distance Z from the interface region between the teeth 13 and the base 14 which is substantially equal to the size of the prosthetic body of the prosthesis 15 at that region.

With reference to FIG. 4, advantageously, the body 11 is shaped to be complementary to the assembly 16 and to enclose:
the prosthesis 15 entirely,
the base 14 at least partially.

The body 11 has a bottom 17 which duplicates the plurality of teeth 13 of the prosthesis 15 and one or more through inlets/holes 18 in the bottom 17.

These inlets/holes 18 are adapted to allow the injection and/or the casting of resins in order to provide the prosthetic body, not shown in the figures, once the device 10 is in the configuration for use, shown in FIG. 4, coupled to the assembly 16.

In practice, the inlets/holes 18 make the resin pressing/finalization of the prosthesis 15 possible.

Advantageously, the casting or injection of acrylic resin occurs with the device 10 coupled to the assembly 16 in the overturned configuration and not the configuration shown in FIG. 4, i.e. with the bottom 17 of the body 11 directed upward.

Another of the peculiarities of the invention consists in that the device 10 is made of light-curing resin, using 3D printing.

Another peculiarity of the invention consists of the method for providing the device 10.

This method for providing the device 10 consists in the following steps:
taking photographs of the face and mouth of the patient,
transferring these photographs using software to form a digital model of the face of the patient and of the edentulous surfaces,
photographically analyzing the physiognomic characteristics of the face of the patient,
using a photographic database containing a library of artificial teeth, selecting, positioning and viewing, in 2D format, the dental shapes that are most suited to the type of face being considered,
importing in 3D digital format, from a predefined database, the dental shapes selected and viewed previously in 2D format, arranging them on the digital model of the edentulous surfaces obtained from the photographs, thus obtaining a dental composition that is anatomically and functionally correct for the specific patient, in so doing producing a digital prototype,
digitally modeling the prosthetic body of the prosthesis 15, designing its peripheral limits and the portions for joining to the artificial teeth that were positioned beforehand on the digital prototype, thus obtaining an overall digital model of the prosthesis 15 which is coupled to the edentulous surfaces obtained from STL files of the models or of the arches deriving from scans/photographs,
drawing the device 10, faithfully tracing the overall digital model obtained in the preceding step,
exporting the STL file of the drawing of the device 10, obtained in the preceding step, in a CAD/CAM environment for production by 3D printing,
providing the device 10 by 3D printing.

It should be noted that such method makes it possible to obtain a device for the resin pressing and finalization of an individual dental prosthesis that is specific to a certain patient and uniquely dedicated to that patient.

This makes it possible to reduce to the minimum the clinical sittings at the dental surgery, in that the modeling of the prosthesis is done almost exclusively digitally.

In practice it has been found that the invention fully achieves the intended aim and objects by providing a device for the resin pressing and finalization of fully or partially removable dental prostheses that enables the resin pressing and finalization of prostheses via the injection or casting of resins, such as special acrylic resins for permanent use in the oral cavity and for use with commercial dedicated artificial teeth.

According to the invention a device for the resin pressing and finalization of fully or partially removable dental prostheses, and a method for providing it, are provided which make it possible to reproduce both the impression of the morphology of the artificial teeth, defined by previously-selected dental shapes, and also the impression of the morphology of the anatomically-modeled prosthetic body in order to reproduce the shape of the gingival necks and the shape of the entire gingival vestibule of the mouth of the patient.

In addition, according to the invention a method has been developed for providing a device for the resin pressing and finalization of fully or partially removable dental prostheses that is adaptable solely to the patient being fitted, and with which it is possible to obtain a total or partial prostheses while reducing to the minimum the number of clinical sittings at the dental surgery.

The invention thus conceived is susceptible of numerous modifications and variations, all of which are within the scope of the appended claims. Moreover, all the details may be substituted by other, technically equivalent elements.

In practice the materials employed, provided they are compatible with the specific use, and the contingent dimensions and shapes, may be any according to requirements and to the state of the art.

The disclosures in Italian Patent Application No. 102021000027419 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-7. (canceled)

8. A device for resin pressing and finalization of removable dental prostheses, comprising a single body which is substantially shaped like a tray and reproduces an entire impression of a prosthesis, said prosthesis comprising a plurality of artificial teeth embedded in a prosthetic body.

9. The device according to claim 8, wherein said single body is internally shaped complementarily to an assembly which is constituted by:
an anatomical base, which reproduces an edentulous surface of a patient,
said plurality of artificial teeth of said prosthesis which are mounted on said base, and has, in a configuration for use, a distance Z from an interface region between said artificial teeth and said base which is substantially equal to a size of said prosthetic body of said prosthesis at said interface region.

10. The device according to claim 9, wherein said single body is shaped to be complementary to said assembly and to enclose:
said prosthesis entirely, and
said anatomical base at least partially.

11. The device according to claim 8, wherein said body has a bottom which duplicates said plurality of artificial teeth of said prosthesis and one or more through inlets/holes in said bottom.

12. The device according to claim 8, wherein the device is made of light-curing resin.

13. The device according to claim 8, wherein the device is provided by 3D printing.

14. A method for providing a device according to claim 8, which comprises the steps of:
taking photographs of face and mouth of a patient,
transferring these photographs using software to form a digital model of the face of the patient and of edentulous surfaces,
photographically analyzing physiognomic characteristics of the face of the patient,
using a photographic database containing a library of artificial teeth, selecting, positioning and viewing, in 2D format, dental shapes that are most suited to a type of face being considered,
importing in 3D digital format, from a predefined database, the dental shapes selected and viewed previously in 2D format, arranging said dental shapes on the digital model of the edentulous surfaces obtained from the photographs, thus obtaining a dental composition that is anatomically and functionally correct for the specific patient, in so doing producing a digital prototype,
digitally modeling a prosthetic body of a prosthesis, designing peripheral limits thereof and portions for joining to artificial teeth that were positioned beforehand on the digital prototype, thus obtaining an overall digital model of the prosthesis which is coupled to the edentulous surfaces obtained from STL files of models or of arches deriving from scans/photographs,
drawing said device, faithfully tracing the overall digital model obtained in the preceding step,
exporting the STL file of the drawing of the device, obtained in the preceding step, in a CAD/CAM environment for production by 3D printing, and
providing said device by 3D printing.
